(19) United States
(12) Patent Application Publication
(10) Pub. No.: US 2008/0105754 A1
(43) Pub. Date: May 8, 2008

(54) Heating, Ventilating or Air-Conditioning System

(75) Inventors: Wilhelm Baruschke, Wangen (DE); Dieter Heinle, Pludershausen (DE); Dietrich Klinger, Heubach (DE); Karl Lochmahr, Vaihingen/Enz (DE); Eric Pitz, Stuttgart (DE); Klaus Voigt, Bietigheim-Bissingen (DE)

Correspondence Address: FOLEY AND LARDNER LLP;SUITE 500, 3000 K STREET NW, WASHINGTON, DC, 20007, US

(73) Assignee: BEHR Gmbh & CO. KG

(21) Appl. No.: 10/585,765

(22) PCT Filed: Jan. 14, 2005
(86) PCT No.: PCT/EP05/00352

§ 371 Date: Dec. 17, 2007

(30) Foreign Application Priority Data
Jan. 15, 2004 (DE) 10 2004 002 364.6
Jun. 1, 2004 (DE) 10 2004 026 912.2

(51) Int. Cl. G05D 23/19; B60H 1/34

(52) U.S. Cl. 236/91 F; 454/155

(57) ABSTRACT

The invention relates to a heating, ventilating or air-conditioning system, particularly for motor vehicles, and to a method for operating a system of this type, particularly for controlling the outflow characteristics (18) of a vent (1).

The invention relates to a heating, ventilating or air-conditioning system and to a method for operating such a system.

The above systems supply in particular the passenger compartment of a vehicle with air. In such systems, depending on the operating state, the air is heated or cooled before it passes into the passenger compartment in order to lower or raise the temperature to a predefinable value in a specific area. The air can also be dehumidified by means of the system and cleaned by means of a filter.

In special operating states, the temperature of the passenger compartment, in particular the air of the passenger compartment, is clearly different from the desired or presettable temperature. For example, in the summer it is frequently the case that the temperature of the passenger compartment differs significantly from the setpoint temperature since the vehicle has heated up greatly owing to solar radiation.

In such operating states, large quantities or air or air mass flow rates of cold air are required to cool the passenger compartment of a vehicle quickly to a lower temperature.

Likewise, in the winter when a vehicle is stationary for a relatively long time, the temperatures of the passenger compartment may drop to a great extent. The intention is to reduce the difference from the setpoint temperature in the shortest possible time after the vehicle has been activated, which in turn results in large quantities of air or air mass flow rates being required.

In contrast, in other operating states it is not necessary to direct large quantities of air into the passenger compartment since this would give rise to unpleasant draft phenomena for the occupants of said passenger compartment. Nevertheless, it is necessary to feed in a certain amount of conditioned air.

A significant contribution to the sensation of comfort or comfortableness for an occupant of the vehicle can be made for these operating states not only by the quantity but also the flow characteristic of the air to be introduced into the passenger compartment of the vehicle.

The object of the invention is therefore to provide an air-conditioning system which, in the case of first operating states, ensures a high air throughput rate and/or a directed jet of air, and, in second operating states, would, for a given air throughput rate, be felt to be not unpleasant, in particular with respect to draft phenomena. Furthermore, the object is to provide a corresponding method for performing open-loop or closed-loop control or making settings.

According to the invention, this is achieved with a heating, ventilating or air-conditioning system having a housing in which, if appropriate, at least one heat exchanger such as a heating element and/or vaporizer is accommodated, for the purpose of conditioning the air, having a blower with at least one air duct for feeding preferably conditioned air to an air outflow vent, and having at least one air outflow vent from which air streams out preferably into a passenger compartment of a vehicle, the outflow characteristic of the air outflow vent being adjustable in a controllable fashion between a first characteristic with a scatter character and a second characteristic with a spot character.

As a result, the invention allows a first characteristic to be set in first operating states. In such operating states it is possible, for example, for an increased quantity of air to be required so that as a result of the spot character better mixing of the air can be achieved when there are large quantities of air per time unit. As a result, the invention also ensures that in second operating states a second characteristic can be set. In such operating states it is possible, for example, for a reduced quantity of air to be required so that as a result of the scatter character better mixing of the air can be achieved for reduced quantities of air per time unit.

According to one exemplary embodiment it is preferred if the outflow characteristic can be varied by means of a settable swirl. In this context it may be expedient if the swirl of the at least one air stream can be set between a maximum value for the scatter characteristic and a minimum value for the spot characteristic. It may be expedient in this context if the swirl in the spot characteristic is reduced to considerably reduced or even completely eliminated in another exemplary embodiment.

In a further exemplary embodiment it is expedient if the outflow characteristic of at least one outflow vent can be set or open-loop controlled or closed-loop controlled as a function of at least one parameter and/or at least one operating state. This may preferably be done in such a way that when the at least one parameter or the operating state changes, the characteristic of the outflow vent also changes under open-loop or closed-loop control. In this context it can also be advantageous if the outflow characteristic can be open-loop controlled, closed-loop controlled or set as a function of at least one parameter as a deviation from a setpoint value or as a difference from a setpoint value. In one preferred exemplary embodiment this may lead to a situation in which the characteristic of the outflow vent changes when there is a change from a setpoint value. For example, the characteristic of the outflow vent can change from the spot characteristic to the scatter characteristic under open-loop or closed-loop control as an approximation of the actual value to the setpoint value.

In a further preferred exemplary embodiment, the outflow characteristic can be open-loop controlled, closed-loop controlled or set as a function of a parameter field or characteristic diagram of a plurality of parameters.

It is preferred if a parameter is a variable of the passenger compartment temperature, the solar radiation, the external temperature, the speed of the vehicle or a time parameter.

According to the invention, it is advantageous if the outflow characteristic of an outflow vent can be set to spot character when there is a first deviation of the actual value from a setpoint value. It is also expedient if the outflow characteristic can be set to scatter character when there is a second deviation of the actual value from a setpoint value. It is particularly expedient if the outflow characteristic can be set to an intermediate position (intermediate setting) between the spot character and scatter character for actual values between the first and second setpoint values. This means that in an intermediate position or intermediate setting it is possible to set a characteristic which has a partially spot character and a partially scatter character.

In some exemplary embodiments it is expedient if, when the spot character is set, the quantity of air which can flow out of the respective outflow vents is maximized. In such a case, the air-conditioning system is set to essentially maximum air outflow so that the quantity of air which can flow out is preferably at a maximum.

It is preferred if, when the scatter character of the outflow vent is set or closed-loop controlled or open-loop controlled, the quantity of air which can flow out is reduced compared to the maximum value. This reduction can be by a predefinable value (percentage value) or else be controllable as a function of other variables, the temperature or a time variable.

According to the invention, the air outflow vents are preferably embodied as footwell air outflow vents, ventilation air outflow vents, defrosting air outflow vents or side air outflow vents. An air outflow vent is preferably arranged in the trim areas or pillar areas, for example of the A, B or C pillar, of the passenger compartment of the vehicle. It proves advantageous to arrange air outflow vents particularly in areas in which a directed flow of air can be directed at a vehicle occupant or individual parts of the body of a vehicle occupant by means of a spot characteristic of the outflow vent. For example, it is thus possible for a foot outflow vent to be directed very accurately onto the feet of a driver in the direction of the accelerator pedal or brake pedal.

According to the invention, a method is also made available for controlling a heating, ventilating or air-conditioning system, the system being equipped, for example, with at least one sensor for sensing the at least one actual value and an open-loop control system/open-loop control unit for determining and comparing the at least actual value with at least one setpoint value and for actuating an actuator element of an outflow vent for actuating or setting the characteristic of at least one outflow vent. The sensor can also be replaced/supplemented by a control program or a computer program or in some other way if the actual value cannot be determined by measuring but rather by using other data. For example, it is possible to use an existing sensor or data of a sensor which is made available by another open-loop control unit.

In a method for controlling a heating, ventilating or air-conditioning system according to the invention, the outflow characteristic and/or the outflow setting of the at least one air outflow vent is open-loop controlled or closed-loop controlled as a function of at least one parameter P.

The open-loop control or closed-loop control of the outflow characteristic and/or of the outflow setting of the at least one air outflow vent preferably takes place as a function of the deviation of an actual value from a setpoint value.

In a further refinement of the method according to the invention, the outflow characteristic of the at least one air outflow vent is changed according to a chronologically predetermined sequence.

According to the invention, in a further refinement of the method, the outflow characteristic and/or the outflow setting of the outflow vent is kept constant at a first outflow characteristic and/or first outflow setting as a function of the at least one parameter P starting from an initial value P0 until a parameter value P1 is reached, and after the parameter value P1 is reached it is changed automatically in a continuous fashion or in discrete increments up to a second outflow characteristic and/or outflow setting until a parameter value P2 is reached.

After the parameter value P2 is reached, the outflow setting of the outflow vent is preferably changed automatically in a continuous fashion or in discrete increments up to a third outflow setting until the parameter value P3 is reached, in particular it is reduced to a predetermined value, the outflow characteristic being kept constant.

The at least one parameter P is advantageously an internal air temperature, external air temperature and/or air outlet temperature and/or a time parameter. The corresponding temperature values are preferably measured with a sensor and are made available to an evaluation unit and open-loop or closed-loop control unit as parameter values.

The first outflow characteristic advantageously corresponds to an essentially directed outflow or spot flow and preferably the second outflow characteristic corresponds to a scatter characteristic or an essentially diffuse outflow.

According to the invention, the definition of a time T0 for the start of the sequence of the method is carried out by switching on the heating, ventilating or air-conditioning system or by activating the motor vehicle.

The parameter values P1, P2 and/or P3 are preferably defined as a function of a characteristic diagram and made available or fed to a closed-loop or open-loop control unit for the sequence of the method according to the invention.

The invention is explained in more detail below with reference to the drawing, in which:

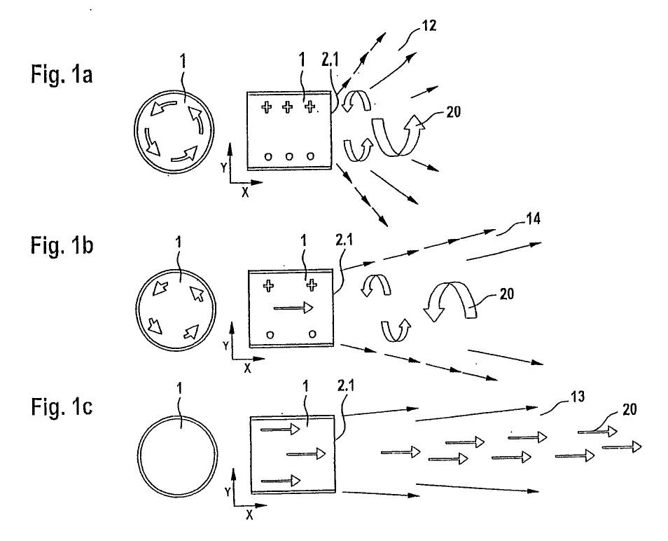

FIG. 1 is an illustration of possible outflow characteristics of a first embodiment of the invention;

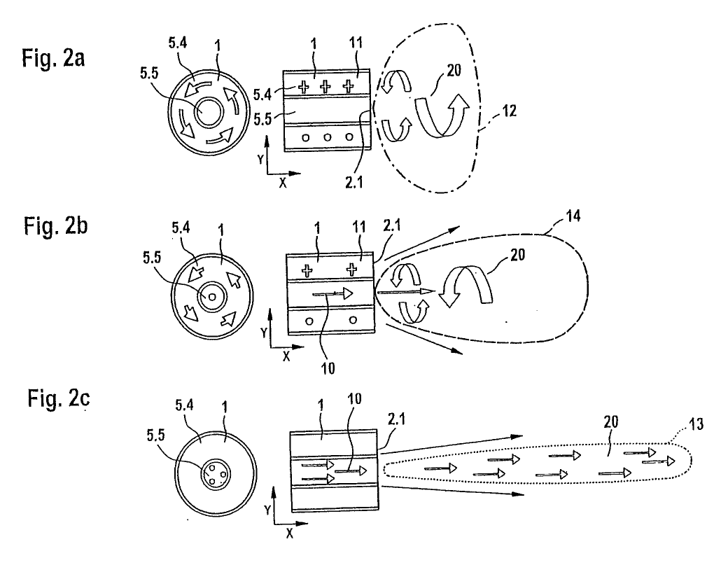

FIG. 2 is an illustration of possible outflow characteristics of a second embodiment of the invention;

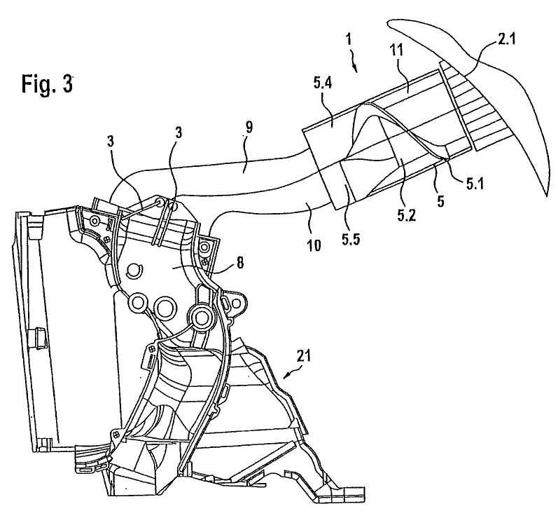

FIG. 3 is a schematic illustration of an air guiding means with air outflow vent for a motor vehicle;

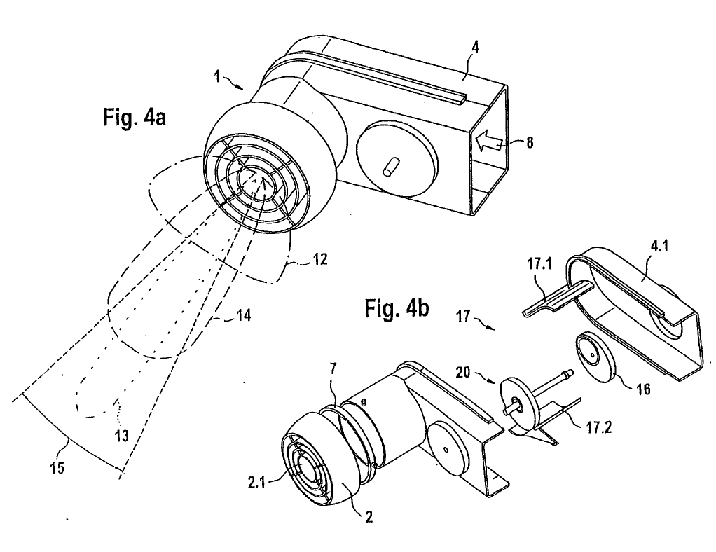

FIG. 4a is a schematic illustration of a first exemplary embodiment of the invention with outflow characteristic;

FIG. 4b is a schematic illustration of individual components of the first exemplary embodiment of the invention;

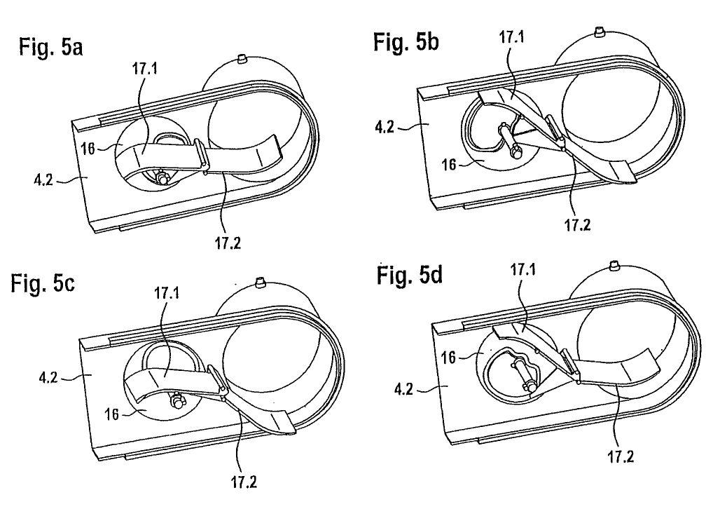

FIGS. 5a to 5d show illustrations of a metering device and an air guiding device of the first exemplary embodiment for different, set outflow characteristics;

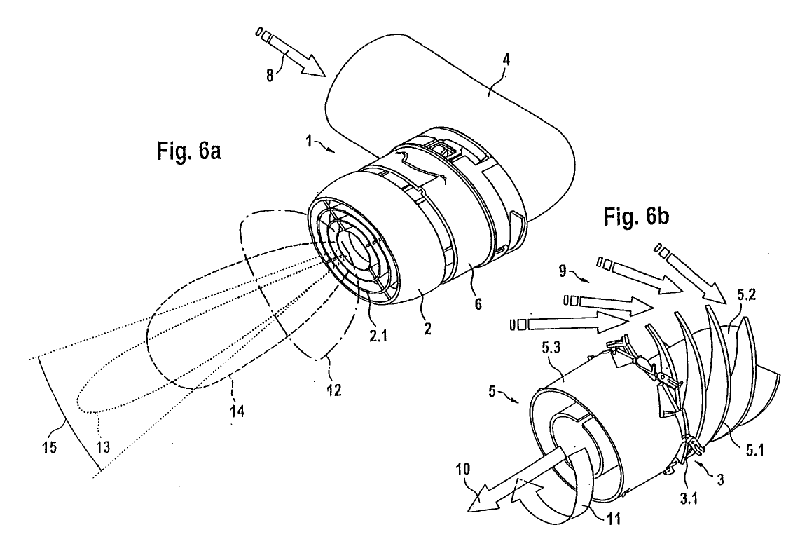

FIG. 6a shows a schematic illustration of a second exemplary embodiment of the invention with outflow characteristic;

FIG. 6b shows a schematic illustration of the air guiding means within the air guiding device of the second exemplary embodiment;

FIG. 6c shows a schematic illustration of individual components of the second exemplary embodiment of the invention;

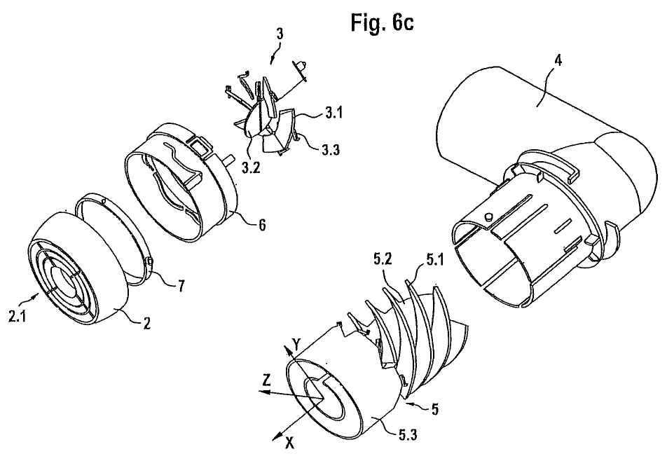

FIG. 7a shows a schematic illustration of the air guiding device of the second exemplary embodiment;

FIG. 7b shows a schematic illustration of the metering device of the second exemplary embodiment;

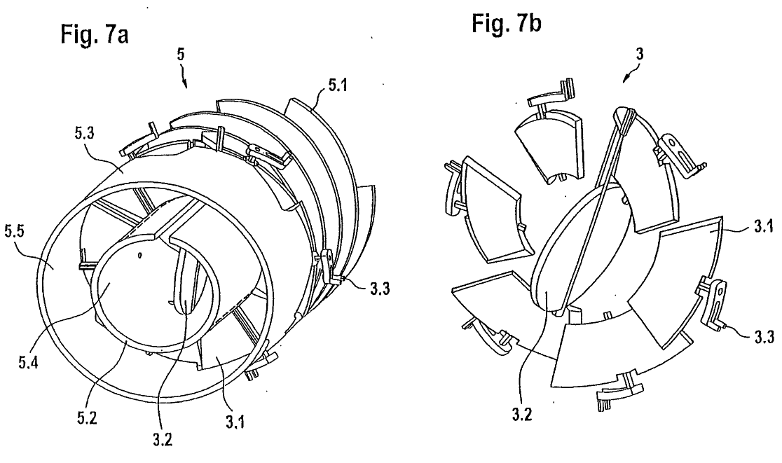

FIG. 8 shows a schematic illustration of a further exemplary embodiment for an air guiding device;

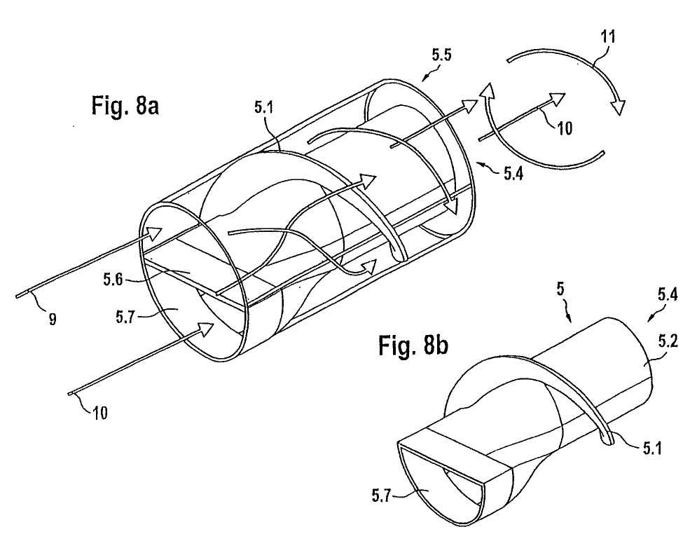

FIG. 9 shows an illustration of a passenger compartment of a vehicle with the air outflow vents according to the invention;

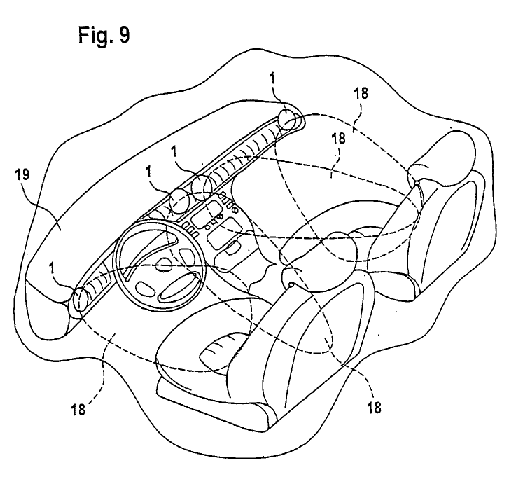

FIG. 10 shows a schematic illustration of an air-conditioning system according to the invention;

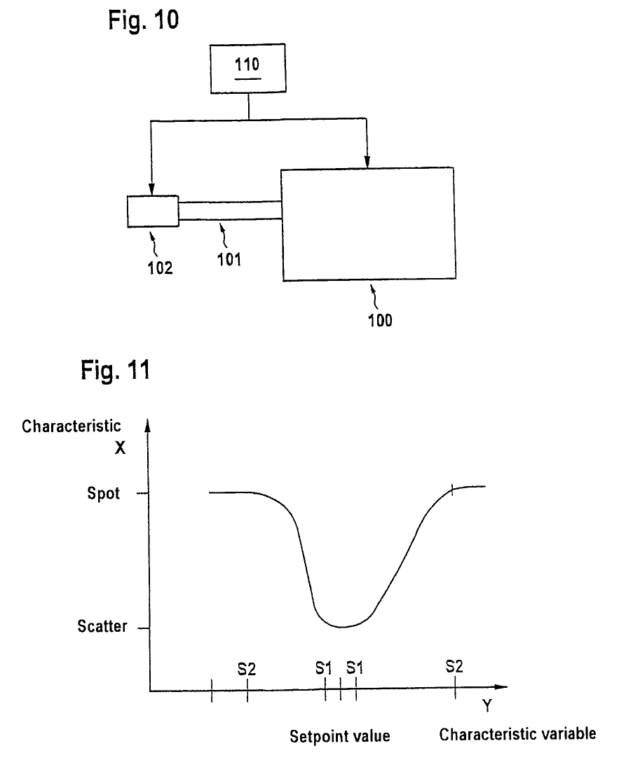

FIG. 11 shows a schematic illustration of a profile of a characteristic; and

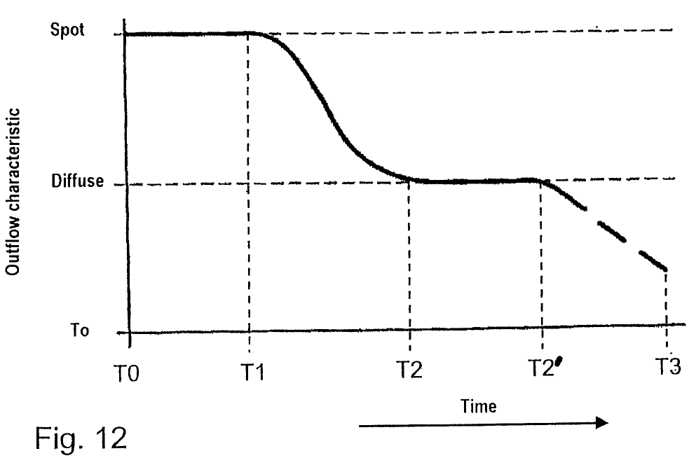

FIG. 12 shows a schematic illustration of a profile of a characteristic according to a further exemplary embodiment.

FIG. 1 shows illustrations of possible outflow characteristics of a first embodiment of the invention in which a settable swirl is applied to a single, fed-in air stream in order to change the outflow characteristic of an air outflow vent 1.

For example, FIG. 1a shows an air outflow vent 1 for a motor vehicle, in which a strong swirl is applied to the axially emerging air stream 20. For this reason, an outflow area 12 with a scatter characteristic, i.e. the air stream 20 emerging from the air outflow vent 1 is highly diffused and there is only weak distribution in the X direction, forms in front of an outlet opening 2.1 of the air outflow vent 1.

FIG. 1b shows an air outflow vent 1 for a motor vehicle in which a swirl is applied to the axially emerging air stream 20. For this reason, an outflow area 14 with a mixed characteristic 12 is formed, i.e. the air stream 20 emerging from the air outflow vent is diffused to a lesser degree than for the scatter characteristic and there is a medium degree of distribution in the X direction, is formed in front of the outlet opening 2.1 of the air outflow vent 1.

FIG. 1c shows an air outflow vent 1 for a motor vehicle in which a swirl is not applied to the axially emerging air stream 20. For this reason, an outflow area 13 with a spot characteristic, i.e. the air stream 20 which emerges from the air outflow vent is hardly diffused at all and there is a high degree of distribution in the X direction, is formed in front of the outlet opening 2.1 of the air outflow vent 1.

FIG. 2 shows illustrations of possible outflow characteristics of a second embodiment of the invention in which a single, fed-in air stream is divided into at least two partial air streams 9, 10, a first partial air stream 10, in the illustrated exemplary embodiment a so-called core air stream 10 without swirl, is fed to the outlet opening 2.1, and a second partial air stream 9, in the illustrated exemplary embodiment as a so-called outer air stream 11 to which a settable swirl is applied, is fed to the outlet opening 2.1. The core air stream 10 is guided in a core duct 5.5, and the outer air stream 11 is guided in an outer duct 5.4 of the air outflow vent 1. By dividing the fed-in air stream 8 into a plurality of partial air streams it is possible to define and control the described outflow characteristics better, while division in particular into two partial air streams is easy to implement.

For example, FIG. 2a shows the air outflow vent 1 in which only the outer air stream 11 to which a swirl is applied is guided to the outlet opening 2.1. For this reason, in front of the outlet opening 2.1 of the air outflow vent 1, the outflow area 12 is formed with a scatter characteristic, i.e. the air stream 20 which emerges from the air outflow vent 1 is highly diffused and there is only weak distribution in the X direction. This outflow area is also referred to as a scatter area or as a diffuse area.

FIG. 2c shows the air outflow vent 1 for a motor vehicle in which only the core air stream 10 is guided to the outlet opening 2.1. For this reason, in front of the outlet opening 2.1 of the air outflow vent 1, an outflow area 13 with a spot characteristic is formed, i.e. the air stream 20 emerging from the air outflow vent 1 is hardly diffused at all and there is a high degree of distribution in the X direction. The outflow area 13 is also referred to as a spot area.

FIG. 2b shows the air outflow vent 1 for a motor vehicle in which both the core air stream 10 and the outer air stream to which a swirl is applied are guided to the outlet opening 2.1. The two air streams 10, 11 influence one another and a third area 14 is produced in which the two air streams 10, 11 are distributed, the shape of the third area 14 being dependent on the proportion which the two air streams make up of an instantaneous air distribution. In other words, depending on the distribution of the mass air stream rate between the core air stream 10 and the outer air stream 11, the core air stream 10 is destabilized by the swirl which is impressed by the outer air stream 11 and correspondingly diffused or the outer air stream 11 to which the swirl is applied is transported further in the X direction by the core air stream 10 as a function of the distribution of the mass air stream rate, as a result of which the diffusing process by the swirl does not become effective until at a relatively large distance from the outflow opening 2.1. As a result, any possible distribution of air or outflow characteristic can be implemented between the two extreme values of only outer air stream 11 and scatter characteristic or only core air stream 10 and spot characteristic, depending on the distribution of the mass air stream rate.

FIG. 3 shows a schematic illustration of an air guiding means with an air outflow vent 1 according to the invention in a motor vehicle. The air outflow vent corresponds here to the second embodiment described above, i.e. a first partial air stream 10 is guided to the outlet opening 2.1 via the core duct 5.5, and a swirl is applied to a second partial air stream 9 in the outer duct 5.4 by corresponding air guiding elements 5.1 and guided to the outlet opening 2.1 as an outer air stream 11 to which a swirl has been applied. The distribution of air in the air stream 8 which is fed in is set here by a metering device which is arranged in an air-conditioning unit 21 and is implemented in the illustrated exemplary embodiment by two flaps with associated actuating means.

FIG. 4 shows a possible embodiment of the first exemplary embodiment of the invention. For example, FIG. 4a shows a schematic illustration of the first exemplary embodiment of the invention with various outflow characteristics, and FIG. 4b shows a schematic illustration of individual components of the first exemplary embodiment. As is apparent from FIGS. 4a and 4b, in the first exemplary embodiment the air outflow vent 1 adjoins an air duct 4 which feeds in an air stream 8. The air outflow vent 1 comprises a metering/air distribution device 17 which is already arranged in the air duct 4. The metering/air distribution device 17 comprises a two-component air guiding vane 17.1, 17.2 and a cam 16 with an associated drive 20, the air guiding vane comprising an upper vane 17.1 and a lower vane 17.2. The metering/air distribution device 17 is adjoined by a pivot ring 7 and a pivotable shutter 2 with an outflow opening 2.1 for setting the outflow direction within a pivot range 15. The air outflow vent 1 is used to implement the first, second and third areas 12, 13, 14 of the air distribution already described in front of the outflow opening 2.1, and the associated outflow characteristics, and is explained below with reference to FIGS. 5a to 5d.

FIG. 5 shows the air duct 4 with the air duct upper part 4.1 removed, and the metering/air distribution device 17 arranged therein with different settings of the two vanes 17.1, 17.2 in order to achieve the different outflow characteristics.

FIG. 5a shows the two vanes 17.1, 17.2 in a center position in order to achieve the outflow characteristic of the third area 14 illustrated in FIG. 1b, in which area 14 the axially emerging air stream has a swirl applied to it, the spot characteristic being increased by lowering the lower vane 17.2 in the direction of the lower air duct wall, with the scatter characteristic being increased by raising the upper vane 17.1 in the direction of the upper air duct wall.

FIG. 5b shows the position of the two vanes 17.1, 17.2 in a closed position of the air outflow vent 1 in which an air stream does not emerge at the outflow opening 2.1, i.e. the two vanes 17.1, 17.2 shut off the entire cross-sectional face of the air duct 4, with the upper vane 17.1 bearing in a seal-forming fashion against an upper wall, and the lower vane 17.2 bearing in a seal-forming fashion against a lower wall of the air duct 4.

FIG. 5c shows a position of the vanes 17.1, 17.2 with which the spot outflow characteristic of the second area 13 which is illustrated in FIG. 1c is achieved. The upper vane 17.1 is located here in a virtually horizontal position, while the lower vane 17.2 closes the lower area of the air duct 4 so that the air stream on the upper side of the vanes 17.1, 17.2 is guided virtually without swirl to the outflow opening 2.1.

FIG. 5d shows a position of the vanes 17.1, 17.2 with which the scatter outflow characteristic of the first area 12 illustrated in FIG. 1a is achieved. The lower vane 17.2 is located here in a virtually horizontal position, while the upper vane 17.1 closes off the upper area of the air duct 4 in a seal-forming fashion so that the air stream is guided along the underside of the vanes 17.1, 17.2 into an edge area of the air duct 4, as a result of which a swirl is impressed on the air stream and the air stream is then guided to the outflow opening 2.1 with said swirl.

As is apparent from FIG. 6c, the second exemplary embodiment of the air outflow vent 1 according to the invention comprises a shutter 2 with an outflow opening 2.1, a metering device 3, an air guiding device 5, an actuating ring 6, and a pivot ring 7, the air outflow vent 1 adjoining an air duct 4.

For example, FIG. 6a shows a completely assembled air outflow vent 1 in which the air guiding device 5 is pushed into the air duct 4, the metering device 3 being arranged in the region of the air guiding device 5 (see FIG. 6b), in which case, in order to set the metering device 4, the actuating ring 6 is pushed over a front area 5.3 of the air guiding device 5 until the actuating ring 6 engages in the metering device 3. The air guiding device 5 divides an air stream 8, fed to the air outflow vent 1 via the air duct, into two partial air streams 9 and 10, as is apparent from FIG. 6b, by means of air guiding elements 5.1, 5.2, the metering device 3 comprising means 3.2 for metering the first partial air stream 10 and means 3.1 for metering the second partial air stream 9, and the means for metering 3.1, 3.2 preferably comprising individual flaps or air guiding elements which can be set by the actuating ring 6 by means of corresponding intervention means 3.3 which are arranged on the metering device 3. A swirl is impressed on the second partial air stream 9 by means of the guiding elements 5.1 or by means of the metering device 3 so that the second partial air stream 9 leaves the air guiding device as a second partial air stream 11 to which a swirl has been applied. The air guiding element 5.2 guides the first partial air stream 10, without a swirl being impressed, through the air guiding device to the shutter 2 which forms, with the pivot ring 7, a device for setting a pivot area 15 of the air outflow vent 1 with which the direction of the air stream can be set in the area of an outlet opening 2.1. The outlet opening 2.1, and thus also the device 2, 7, for setting the direction of the air stream, are installed in a dashboard 19 (see FIG. 9) of a motor vehicle, and the vehicle occupant can thus set a desired direction of the air stream directly and also vary the outflow areas 18 which are associated with the individual air outflow vents 1.

FIGS. 7a and 7b show the air guiding device 5, with the metering device 3, and the metering device 3 in detail. As is apparent from FIG. 7b, the metering device 3 comprises a first flap 3.1 for metering the second air stream 9 or the outer air stream 11, and a second flap 3.2 for metering the first air stream 10 or the core stream. In addition, there are means 3.3 which engage in the actuating ring 6 illustrated in FIG. 6 so that the flaps 3.1, 3.2 for metering the partial air streams 9, 10 can be adjusted by means of the actuating ring 6. With the metering device 3 and/or the air guiding device 5 it is possible to change the guiding of air and/or the quantity of air and/or the speed of air and thus the outflow characteristic of the fed-in air stream 8 in order to generate the swirl.

As is apparent from FIG. 7a, the air guiding device 5 divides the fed-in air stream 8 into two partial air streams in the illustrated exemplary embodiment. The division takes place in the radial direction so that in a central area 5.4 of the air guiding device 5 the core air stream is guided in a core duct 5.4 in the axial direction with respect to the outflow opening 2.1, and in an outer area 5.5 the outer air stream 11 to which a swirl is applied is guided in an outer duct 5.5 to the outflow opening 2.1. The second partial air stream 9 is guided in a helical shape about the central core duct 5.4 by the air guiding elements 5.1 and receives a swirl in the clockwise or counterclockwise direction depending on the orientation of the air guiding elements 5.1, as is indicated in the figures by corresponding arrows in the area of the air outlet. In contrast to the illustrated exemplary embodiment, it is however also conceivable to use suitable air guiding elements to apply a swirl to the core air stream 10 which is guided in the central area 5.4, and to guide said core air stream 10 to the outflow opening 2.1 and to guide the outer air stream 11, which is guided essentially without swirl in the outer area, to the outflow opening 2.1.

As is apparent from FIGS. 6b and 7a, the partial air streams can also be divided once more into component air streams, which applies to the second partial air stream 9 in the illustrated first exemplary embodiment. Here, the individual air guiding elements 5.1 form a plurality of component outer ducts whose flow cross sections can be changed individually or together by corresponding flaps 3.1 in the metering device 3. The individual component ducts are joined again to form an outer duct 5.5 in the front region of the air guiding device 5.3, in which outer duct 5.5 the outer air stream 11 to which a swirl is applied is guided to the outflow opening 2.1.

The metering device 3 is set directly by the vehicle occupant by means of an actuating element arranged on the dashboard 19 or automatically by an open-loop/closed-loop control unit in accordance with a ventilation and/or air-conditioning program selected by the user.

FIG. 8 shows in detail the air guiding device 5 illustrated in FIG. 3. As already stated, the metering and the division of the air stream 8 already take place in the air-conditioning unit 21. As in FIG. 8a, the first partial air stream 10 and the second partial air stream 9 are fed in to the air guiding device 5 via corresponding air ducts. The first partial air stream 10 enters a lower area 5.7 of the air guiding device 5 and leaves the outflow opening 2.1 as a core air stream in a core duct 5.4. The second partial air stream 9 enters an upper area 5.6 of the air guiding device 5, has a swirl applied to it by an air guiding element 5.1 and leaves the outflow opening 2.1 as an outer air stream 11 in an outer duct 5.5. The second partial air stream 9 is guided in a helical shape about the central core duct 5.4 by the air guiding elements 5.1 and receives a swirl in the clockwise direction or counter-clockwise direction depending on the orientation of the air guiding elements 5.1, as is indicated in the figures by corresponding arrows in the area of the air outlet. In contrast to the illustrated exemplary embodiment, it is however also conceivable to apply a swirl to the core air stream 10 by means of suitable air guiding elements and to guide it to the outflow opening 2.1 and to guide the outer air stream 11 essentially without swirl to the outflow opening 2.1.

FIG. 10 shows a schematic illustration of a device according to the invention. In particular a heating, ventilating and/or air-conditioning system 100 can be seen. This preferably contains heat exchangers such as a heating element and/or a vaporizer as well as air ducts and air stream control elements such as flaps for conditioning and/or distributing the air. At least one air duct 101 leads from this air-conditioning system to an outflow vent 102. The air preferably passes through the outflow vent 102 into the passenger compartment of the vehicle.

The control unit 110 controls both the air-conditioning system 100 and the outflow vent 102 here. The characteristic of the outflow vent can be controlled here so that the characteristic can either be set to a spot characteristic or to a scatter characteristic. In an intermediate setting it is also possible to set or open-loop control a characteristic which can be set between the spot and scatter characteristics.

FIG. 11 shows a function of the characteristic X of an outflow vent as a function of a characteristic variable Y, for example a parameter P, which can be a temperature variable such as, for example, the passenger compartment temperature. Here, the characteristic is set to spot as long as a deviation of the actual value from the setpoint value exceeds a predefinable value. When the value drops below the threshold value S2, the characteristic of the spot characteristic is adjusted in the direction of the scatter characteristic, with the characteristic assuming the scatter characteristic when the setpoint value is approached if the actual value drops below a further threshold value S1 in comparison with the setpoint value.

The passenger compartment temperature T of the passenger compartment of the vehicle can be used, for example, as a characteristic variable.

In a further exemplary embodiment, the time profile of the outflow characteristic of a driver's foot air outflow vent is illustrated in FIG. 12 as a function of a parameter P, here for example an air outflow temperature. In particular for low external temperatures it is advantageous if the air outlets can be set in a very targeted fashion in particular in the footwell in the heating-up phase.

According to the open-loop characteristic control curve illustrated in FIG. 12, the actuation of the air outflow vent is initiated at the time T0 and set in such a way that the outflow has a maximum spot effect, or the scatter character or the diffuse proportion is minimized. The actuation of the outflow vent is initiated, for example, by switching on the heating, ventilating or air-conditioning system or by activating the vehicle. The air outlet temperature of the outflow vent should not drop below a minimum value (when the air outlet temperature is not sufficient the outflow vent is typically also closed in an automatic air-conditioning system). The initiation time T0 is thus defined for the open-loop control process.

In the heating-up phase, the warm air stream is directed straight at the feet of the driver or front seat passenger by the spot setting of the foot outflow vent or vents in order to generate a pleasant sensation of heat in this area as quickly as possible. At least a sufficient heating power is advantageously available at the time T0 to permit targeted punctual heating. Heating an entire zone of a passenger compartment, for example the entire footwell, is often not yet possible at the time T0 owing to the excessively low heating power.

The spot characteristic which is set at the beginning is kept constant up to a time T1. The definition of the time T1 is advantageously carried out by means of the parameter P1 of the air outlet temperature at the outflow vent, or the temperature of the air entering the footwell. This means that when a specific outflow temperature is reached at the time T1, the outflow characteristic is automatically changed.

According to the illustration in FIG. 12, the outflow characteristic of the outflow vent is changed from a directed or spot outflow to an increasingly diffuse outflow starting from the time T1. This can take place continuously or in discrete adjustment steps at the outflow vent. In the present example, the outflow characteristic is changed up to a time T2 which is defined by means of the parameter P2, the temperature of the air emerging from the outflow vent. Subsequently, the outflow characteristic is retained here and starting from the time T2′ after a specific air outlet temperature (parameter P2′) or an internal air temperature has been reached, the outflowing quantity of air at the outflow vent is reduced, for example by successively closing the air outlet up to a time T3, with the time T3 being in turn predefined by the fact that a specific air outlet temperature (parameter value P3) or an internal air temperature is reached.

However, within the scope of the illustrated method it is also possible for the quantity of air to be varied over the entire profile. It is thus advantageous, at the start, for the outflow to be operated with a high degree of intensity or blowing out intensity for the time period between T0 and T1. This can be done by a low degree of throttling, or no throttling, at the outflow vent. The blowing out intensity can then be reduced in the course of the method.

A device for changing the outflow characteristic of an air outflow vent according to the invention can preferably be integrated into the air-conditioning unit. This can be implemented in particular for the described variant of a foot outflow vent in the front area owing to its spatial proximity to the air-conditioning unit so that, in particular when the outflow vent is integrated into the air-conditioning unit, footwell ducts or at least parts thereof can be dispensed with.

Likewise, a corresponding, further control flap or shutoff flap which is usually provided in the air-conditioning unit for the footwell air outlet can be dispensed with by virtue of the air outlet throttle device or shutoff device provided at the outflow vent.

The described method with changes of the outflow characteristic of an air vent in the heating-up phase at the times T0, T1, T2, T3 typically takes place automatically in accordance with the underlying control criteria. A sequence which is controlled on a purely chronological basis tends to be the exception but is likewise realizable.

The method can of course also be used in an analog fashion for the cooling phase, for example when a vehicle is activated after a relatively long stationary period under very warm or hot weather conditions and/or when there is a large amount of solar radiation.

The method which is presented using the example of a foot outflow vent is also suitable for all other known outflow vents. In particular, under cold and/or damp weather conditions it can advantageously be used for ventilating the front windshield. The directed spot outflow in the heating area or within the time period T0 to T1 can free at least an area of the windshield of possible precipitation or ice as quickly as possible, while the subsequently adjustment to a diffuse outflow permits an unpleasant sensation of overheating in the head area to be largely avoided.

1. A heating, ventilating or air-conditioning system having a housing in which, if appropriate, at least one heat exchanger such as a heating element and/or vaporizer is accommodated, for the purpose of conditioning the air, having a blower with at least one air duct for feeding preferably conditioned air to an air outflow vent, and having at least one air outflow vent from which air streams out preferably into a passenger compartment of a vehicle, the outflow characteristic of the air outflow vent being adjustable in a controllable fashion between a first characteristic with a scatter character and a second characteristic with a spot character.

2. The heating, ventilating or air-conditioning system as claimed in claim 1, wherein the outflow characteristic can be varied by means of a settable swirl.

3. The heating, ventilating or air-conditioning system as claimed in claim 1, wherein the swirl of the at least one air stream can be set between a maximum value for the scatter characteristic and a minimum value for the spot characteristic.

4. The heating, ventilating or air-conditioning system as claimed in claim 1, the outflow characteristic can be set or open-loop controlled or closed-loop controlled as a function of at least one parameter and/or at least one operating state.

5. The heating, ventilating or air-conditioning system as claimed in claim 1, wherein the outflow characteristic can be open-loop controlled, closed-loop controlled or set as a function of at least one parameter as a deviation from a setpoint value or as a difference from a setpoint value.

6. The heating, ventilating or air-conditioning system as claimed in claim 1, wherein at the outflow characteristic can be open-loop controlled, closed-loop controlled or set as a function of a parameter field or characteristic diagram of a plurality of parameters.

7. The heating, ventilating or air-conditioning system as claimed in claim 1, wherein a parameter P is a variable of the passenger compartment temperature, the solar radiation, the external temperature, the speed of the vehicle or a time parameter.

8. The heating, ventilating or air-conditioning system as claimed in claim 1, wherein the outflow characteristic can be set to spot character when there is a first deviation of the actual value from a setpoint value.

9. The heating, ventilating or air-conditioning system as claimed in claim 1, wherein the outflow characteristic can be set to scatter character when there is a second deviation of the actual value from a setpoint value.

10. The heating, ventilating or air-conditioning system as claimed in claim 1, wherein the outflow characteristic can be set to an intermediate position between the spot character and scatter character for actual values between the first and second setpoint values.

11. The heating, ventilating or air-conditioning system as claimed in claim 1, wherein in the case of the spot character the quantity of air which can flow out is maximized.

12. The heating, ventilating or air-conditioning system as claimed in claim 1, wherein in that in the case of the scatter character the quantity of air which can flow out is reduced compared to the maximum value.

13. The heating, ventilating or air-conditioning system as claimed in claim 1, wherein the at least one air outflow vent is a footwell air outflow vent, a ventilation air outflow vent, a defrosting air outflow vent or a side air outflow vent.

14. The heating, ventilating or air-conditioning system as claimed in claim 1, wherein the at least one air outflow vent is arranged in the trim areas or pillar areas of the passenger compartment of the vehicle.

15. A method for controlling a heating, ventilating or air-conditioning system having at least one sensor for sensing the at least one actual value and an open-loop control system for determining and comparing the at least actual value with at least one setpoint value and for actuating an actuator element of an outflow vent for actuating or setting the characteristic of at least one outflow vent, in particular according to claim 1.

16. The method for controlling a heating, ventilating or air-conditioning system as claimed in claim 1, the outflow characteristic and/or the outflow setting of the at least one air outflow vent being open-loop controlled or closed-loop controlled as a function of at least one parameter P.

17. The method for controlling a heating, ventilating or air-conditioning system as claimed in claim 16, wherein the outflow characteristic and/or the outflow setting of the at least one air outflow vent are open-loop controlled or closed-loop controlled as a function of the deviation of an actual value from a setpoint value.

18. The method as claimed in claim 16, wherein the outflow characteristic of the at least one air outflow vent is changed according to a chronologically predetermined profile.

19. The method as claimed in claim 16, wherein the outflow characteristic and/or the outflow setting of the outflow vent is kept constant at a first outflow characteristic and/or first outflow setting as a function of the at least one parameter P starting from its initial value P0 until a parameter value P1 is reached, and after the parameter value P1 is reached it is changed automatically in a continuous fashion or in discrete increments up to a second outflow characteristic and/or outflow setting until a parameter value P2 is reached.

20. The method as claimed in claim 16, wherein after the parameter value P2 is reached, the outflow setting of the outflow vent is changed automatically in a continuous fashion or in discrete increments up to a third outflow setting until the parameter value P3 is reached, in particular is reduced to a predetermined value, the outflow characteristic being kept constant.

21. The method as claimed in claim 16, wherein the at least one parameter P is a temperature parameter and/or a time parameter.

22. The method as claimed in claim 21, wherein the temperature parameter is the passenger compartment air temperature, external air temperature and/or air outlet temperature.

23. The method as claimed in claim 16, wherein the first outflow characteristic corresponds to an essentially directed outflow or spot flow.

24. The method as claimed in claim 16, wherein the second outflow characteristic corresponds to an essentially diffuse outflow.

25. The method as claimed in claim 16, wherein a time T0 for the start of the sequence of the method is defined by switching on the heating, ventilating or air-conditioning system or by activating the motor vehicle. At the time T0, there must be sufficient heating power available to permit targeted, punctual heating.

26. The method as claimed in claim 16, wherein the parameter values P1, P2 and/or P3 are defined as a function of a characteristic diagram.
